(19) United States
(12) Patent Application Publication
(10) Pub. No.: US 2005/0223073 A1
(43) Pub. Date: Oct. 6, 2005

(54) Attaching applets to messaging communications

(76) Inventor: Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/140,447

(22) Filed: May 27, 2005

Related U.S. Application Data
(63) Continuation-in-part of application No. 09/563,929, filed on May 4, 2000, now Pat. No. 6,907,452.

(51) Int. Cl. G06F 15/16

(52) U.S. Cl. 709/206

(57) ABSTRACT

A method and system is disclosed for configuring a messaging communication, including an instant message (IM) communication among others, transmitted in a messaging system in which applets corresponding to attached files in the messaging communication are included. An attachment module attaches a corresponding applet for an attachment file. One or more applets can be associated with a package of attachment files as the attachment files are designated from within user applications. A delayed delivery module transmits the applet to an intermediate location, separately from the messaging communication, where it is stored until requested by a recipient of the messaging communication.

### CROSS-REFERENCE TO RELATED APPLICATIONS

This application is a continuation-in-part of U.S. application Ser. No. 09/563,929, entitled “Method and Apparatus for Attaching Viewer Applets to Electronic Mail Communications,” filed May 4, 2000, incorporated herein by reference.

### NOTICE OF COPYRIGHT PROTECTION

A portion of the disclosure of this patent document and its figures may contain material subject to copyright protection. The copyright owner has no objection to the facsimile reproduction by anyone of the patent document or the patent disclosure, but otherwise reserves all copyrights whatsoever.

### BACKGROUND

The present disclosure relates to the transmission of messaging communications over communication networks, and more particularly, to the transmission of applets attached to electronic mail communications and instant messaging communications, among other types of communication, for at least viewing attachments.

During the past decade, electronic mail (“email”) and instant messaging have become indispensable tools for facilitating business and personal communications. Although email is an effective communication medium, ongoing on-line communications are often hampered because of the extra steps necessary to view, reply, and send email messages. Further, email provides no way of knowing if the person with whom someone is communicating is on-line at that particular moment. With these deficiencies, instant messaging (IM) has gained great popularity over email to facilitate ongoing on-line communications.

Through computer networking systems such as local-area networks (“LAN”), wide-area networks (“WAN”), and the world-wide web (“WWW”), network users can send and receive notes, messages, letters, etc., to communicate with others who are in the same office or perhaps in remote locations across the world. Most email and IM application programs allow a user to attach a file to be sent along with a message as an attachment. Attachment files might include word processing documents, graphics files, audio or video, multimedia presentation files, computer-aided drawing (“CAD”) files, mathematical equation editor files, spreadsheet reports, etc. A recipient will receive the email or IM message plus any attached files, which may then be opened if the recipient's computer has the appropriate application software. In many applications, it is preferable to send documents through email or IM attachments instead of a facsimile because the recipient can then print an exact replica of the original file, or, in the case of IM, the sender can get instant feedback as to whether the intended recipient has received the attachment.

Although many currently available email and IM application programs enable a user to send attachments as part of an email or IM communication, there are problems that recipients often encounter when receiving email or IM attachment files. If a recipient's computer does not have the particular user application software that corresponds with the attachment file, the recipient will not be able to access the attachment. For example, if a sender attaches a CAD document created with CAD software for transmission in an email or IM communication, the recipient might not be able to access or view the file unless the recipient has installed the same CAD software as is installed in the sender's computer. Considering the number of different software vendors that supply software for word processing, graphing, drawing, video editing, CAD, etc., it can be quite common for a recipient to be unable to open an attached document in an email or IM communication. Even if the recipient's computer system supports a particular vendor's software, the recipient might still not be able to access or view the file if the transmitted document was created on a more recent version of this software. In order to view the document, the recipient must then request the sender to save the attachment file in a different format that is compatible with the recipient's software and re-transmit the email or IM communication.

Some email and IM application programs include “quick viewer” features for the recipient of an email or IM attachment file to view the file. These email and IM application programs store viewer applets for many of the popular software packages that are commonly used. The viewer applets are executable files that allow the recipient to view, but not open or edit, a file that was received, when a user selects the received file. While the “quick viewer” feature may allow the recipient to view the majority of transmitted files, there may still be file types that are not supported by the viewer. Particularly, the “quick viewer” may not support specialty software that does not have widespread use. Even with widely-used software packages, the documents composed with the newest version of the software may not be accessible by the “quick viewer” when new versions or upgrades of a software vendor are released. Because of the number of different software packages that are commonly available, it would be impractical to install an upgrade of the email or IM application program each time a commonly-used software package is upgraded. These problems significantly reduce the benefits of email and IM systems and may negatively affect both the sender's and recipient's productivity when engaging in electronic mail or IM communications.

### BRIEF SUMMARY

In view of the difficulties encountered with viewing attachments to email and IM communications described above, there is a need for a method, system, and apparatus for configuring a communication, including email or IM communication, among other types of communication, to include viewer applets with the transmission of desired attachment files.

The present disclosure provides a method for attaching applets to messaging communications, including email or IM communications, among others. The file to be included as an attachment to a messaging communication is received. A corresponding applet is prepared for attachment to the messaging communication. A prompt can be generated for the sender to select whether to include an applet with the messaging communication.

The present disclosure also provides a messaging communications system for attaching applets to messaging communications, including email or IM communications, among others. Messaging communications that include an attachment file are composed on a user interface. A determination module determines whether a messaging communication includes an attachment. An attachment module attaches a corresponding applet for an attachment file.

The present disclosure additionally provides a method for transmitting an applet corresponding to an attachment to a messaging communication, including an email or IM communication, among others. A messaging communication including an attachment to a destination address is transmitted. An applet corresponding to the attachment is then transmitted to an intermediate location along a network. The applet is temporarily stored at the intermediate location. Transmission of the applet is completed in response to a request signal.

### BRIEF DESCRIPTION OF THE SEVERAL VIEWS OF THE DRAWINGS

FIG. 1 is a schematic diagram of a basic computer network system according to an exemplary embodiment of the present disclosure.

FIG. 2 is a schematic diagram of an exemplary embodiment of an email communications system according to the present disclosure.

FIG. 3 is a flow diagram of an exemplary embodiment of attaching viewer applets to an email communication.

FIG. 4 is a flow diagram of an exemplary embodiment of configuring packages of attachment files with corresponding viewer applets.

FIG. 5a is a schematic of an exemplary embodiment of a data structure representation of a package of attachment files.

FIG. 5b is a schematic of an exemplary embodiment of a data structure representation of a header information field in FIG. 5a.

FIG. 6 is a schematic of an exemplary embodiment of a data structure representation of a package of attachment files.

FIG. 7 is a schematic of an exemplary embodiment of an email communications system with a delayed delivery module.

FIG. 8 is a schematic diagram of an exemplary embodiment of two LAN computer networks connected via the internet.

FIG. 9 is a schematic diagram of a basic computer network system according to an exemplary embodiment of the present disclosure.

FIG. 10 is a schematic diagram of an exemplary embodiment of an IM communications system according to the present disclosure.

FIG. 11 is a flow diagram of an exemplary embodiment of attaching applets to an IM communication.

FIG. 12 is a flow diagram of an exemplary embodiment of configuring packages of attachment files with corresponding applets.

FIG. 13a is a schematic of an exemplary embodiment of a data structure representation of a package of attachment files.

FIG. 13b is a schematic of an exemplary embodiment of a data structure representation of a header information field in FIG. 5a.

FIG. 14 is a schematic of an exemplary embodiment of a data structure representation of a package of attachment files.

FIG. 15 is a schematic of an exemplary embodiment of an IM communications system with a delayed delivery module.

FIG. 16 is a schematic diagram of an exemplary embodiment of two LAN computer networks connected via the internet.

FIG. 17 is a schematic of an exemplary embodiment of an IM communication system incorporating a file transfer server.

FIG. 18 is a block diagram of an exemplary embodiment of an IM communications client with a settable flag in an address list.

FIG. 19 is a block diagram of an exemplary embodiment of an IM communication with an applet determination module.

### DETAILED DESCRIPTION

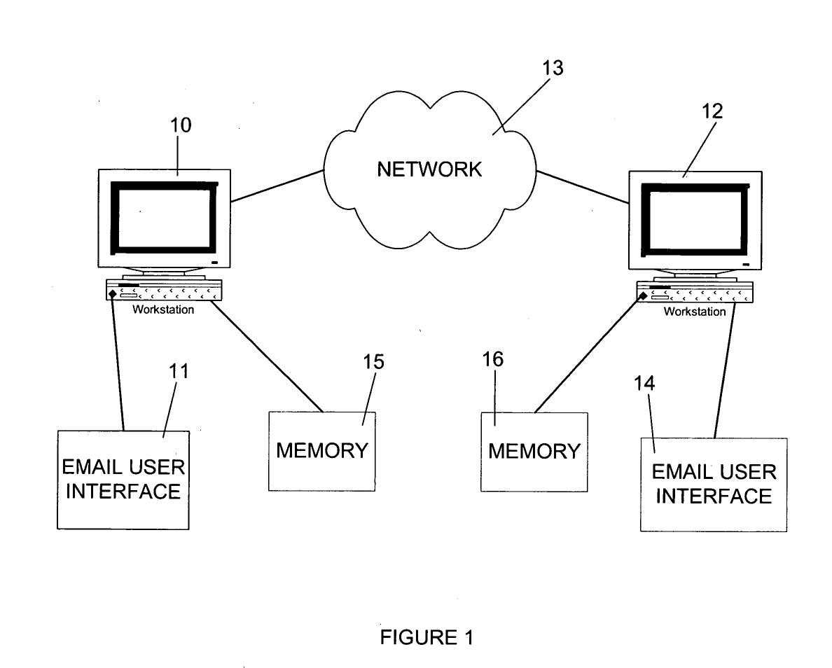

The present disclosure will now be described in more detail with reference to the figures. FIG. 1 is a schematic diagram of a basic computer network system, in which computer 10 is connected to computer 12 through a network 13 to facilitate email communications with attachments. Computer 10 has an email communications user interface 11 that permits the computer to send email communications using network 13. Likewise, computer 12 has an email communications user interface 14 that permits the computer to receive email communications from network 13. The term computer in this description is not limited to any particular type of computer, and may include computer systems having many computers, or only a portion of a computer. Network 13 can be in the form of a wired network or a wireless network. The network may be a simple, single communication path, or it may include one or several LANs or WANs, the world wide web, or any combination thereof. Computers 10 and 12 may be the only computers connected to the network 13, or the network may be shared by many other computers. Computers 10 and 12 additionally include memories 15 and 16, respectively, for storing a plurality of user applications, which may or may not include as non-limiting examples software packages for word processing, CAD, mathematical equation editing, video editing, graphics, multimedia presentations, etc.

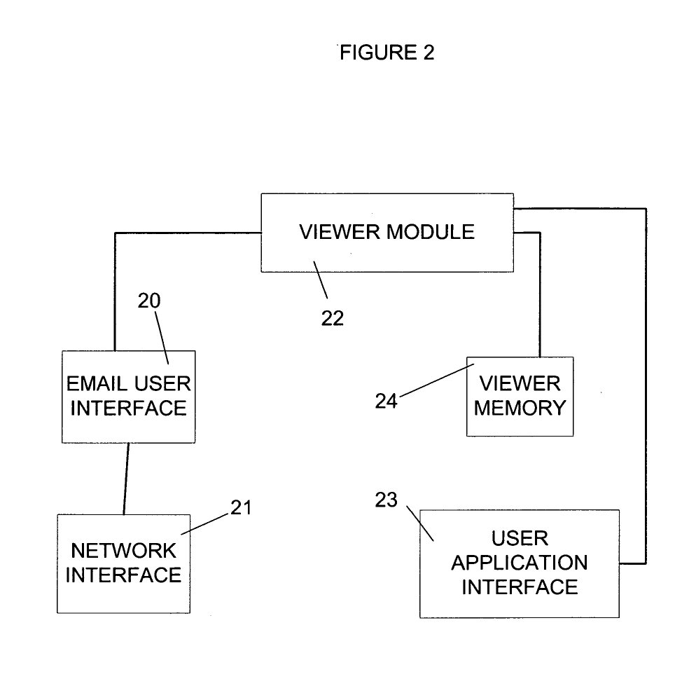

Exemplary embodiments of the present disclosure are directed to a system and method for selectively attaching viewer applets to email communications when it is likely that the recipient of the email communication will not be able to open or view an attachment file that is to be sent in the email. As shown in FIG. 2, an email communications system according to the present disclosure includes an email user interface 20 by which a user composes email communications. A network interface 21 is connected to the user interface for transmitting and receiving email communications, and for transmitting or receiving viewer applets used for viewing attachment files. Email user interface 20 is also connected to viewer module 22. As will be explained below, viewer module 22 controls the placement and transmission of viewer applets in outgoing email communications, and enables a user to view attachment files in incoming email communications. Viewer module 22 is connected to the user application interface 23 to receive viewer applets from other user application software packages that are installed on the user's computer system. Viewer memory 24 stores viewers for commonly-used user applications. Viewer memory 24 may be a special memory bank, or it may be part of memory 15 from FIG. 1.

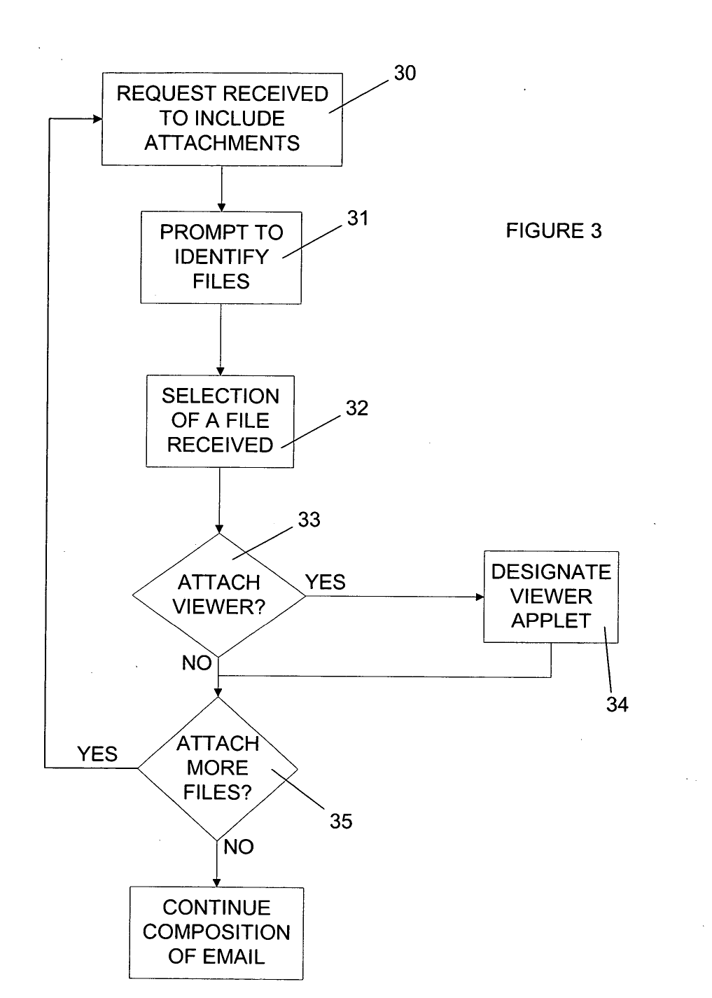

In a first embodiment of the present disclosure, the viewer module 22 of FIG. 2 attaches a viewer applet corresponding to an attachment file during the assembly of an email communication. The flow diagram in FIG. 3 is an example of the steps that could be used to implement this embodiment. When a user elects to include an attachment with an email communication, a signal is sent to the viewer module, as shown in step 30. A menu prompt is provided in step 31 to select one or more files to attach to the email communication. The menu prompt of step 31 is generated in the user-interface 20 shown in FIG. 2. It allows the user to access file information maintained in a document management system in either the email communications system itself, the computer's operating system, or on the network to which the user's computer is attached.

Once a file is selected to be an attachment in step 32, the viewer module 22 determines whether to add the viewer applet that corresponds with the attachment file, in step 33. The viewer module can be configured for several possible modes of operation. In one mode of operation, viewer module 22 always adds the corresponding viewer applet to the email communication. The principal advantage of this mode is that it provides the highest degree of certainty that any recipient should be able to view attachments from the sender, although on many occasions the recipient would otherwise be able to view these files. In a second mode of operation, the sender is prompted to elect whether to include a viewer applet corresponding to the selected attachment. This mode allows the sender to avoid unnecessarily sending the viewer applet when the sender knows that the recipient's computer is capable of displaying the file.

In a third mode of operation, the viewer module prompts the sender to include a viewer applet only when it is likely that the recipient does not have the corresponding viewer applet or application software. This can be performed by referring to a list of file types stored in the viewer memory 24, and only prompting the sender to send a viewer applet when the selected attachment file type is not among those in the list. Another method is to generate the prompt when the sender's own email communication system would not be able to view the attachment. That is, a prompt is generated when the viewer software stored in viewer memory 24 does not include a component for viewing the attached file.

If the sender elects to include a viewer applet, the viewer applet is added to the email communication for transmission to the recipient, in step 34. The viewer applet may be copied from the application software package by which the attachment file was created, through application interface 23 in FIG. 2. It is also possible that the sender's computer has third party viewer software, from which a component corresponding to the relevant application software is then extracted and attached to the email.

This process is repeated until the sender indicates that there are no more attachment files to be selected, in step 35. The sender can then continue to compose the email communication in the normal course.

In a second embodiment, the viewer module is incorporated into a system that allows the user to configure groups of application files attached to an email communication as packages. In this system, the user can designate a file to be a part of a new or an existing package of application files from within the user application software. The packages of application files, as defined by the user, can then be included as an email attachment in a future email communication. At the time when the user designates a file to be an attachment, the viewer module determines whether to include a viewer applet in the email communication by the same modes of operation disclosed with respect to FIG. 3.

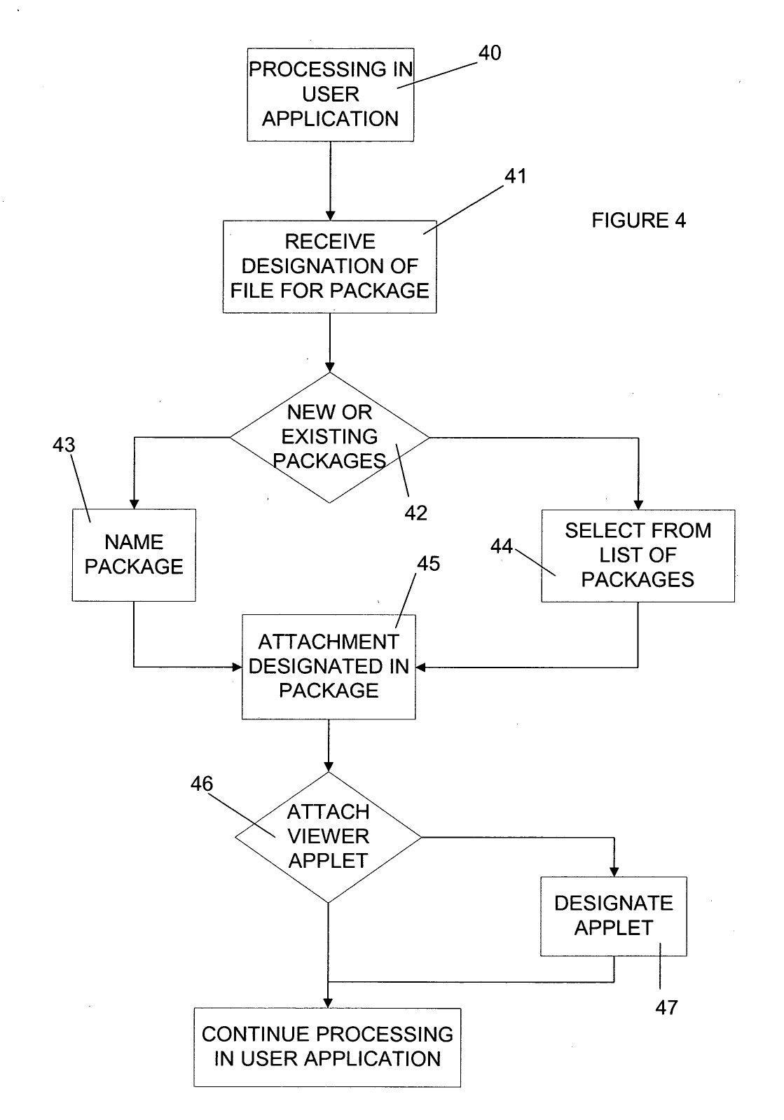

FIG. 4 provides a flow diagram illustrating how the email application interfaces with a user application to coordinate the composition of packages of designated files for attachments and the attachment of viewer applets. A user opens a user application, as in step 40, and begins to process an application file in the normal course. In this context, processing may include creating a new file, or opening and editing an existing file. The application files may be in a text format or any graphics, audio/video, or multimedia-type format. Graphics files might include jpeg, tif, or gif files among others. At any time during processing of the file, the user may choose to designate the application file for a package, as in step 41. This may be done by selecting an icon that is overlaid onto the screen of the user application. Alternatively, the user application itself may incorporate a macro within its menu or in its “toolbar” for creating email attachment packages.

The user is then prompted to select an appropriate package for the designated file, in step 42. As one option, the user may choose to create a new package. If so, the system prompts the user to identify a package name, in step 43. Optionally, the system may create an icon that is to be associated with the package. If the user wishes to add the attachment file to an existing package, the system prompts the user to select from a list of packages, by name or by icon, or to provide the desired package name, in step 44. In step 45, the user application file is now designated as an attachment for a particularly defined package.

When an application file is designated as an attachment, the viewer module 22 in FIG. 2 determines whether to add the viewer applet that corresponds with the attachment file, as in step 33 of FIG. 3. The step of determining whether to attach a viewer applet in step 46 of FIG. 4 can be automatic, user-selected, or a combination of the two, as explained above. If a viewer applet is to be included into the email communication, the applet is designated as another attachment for the defined package in step 47.

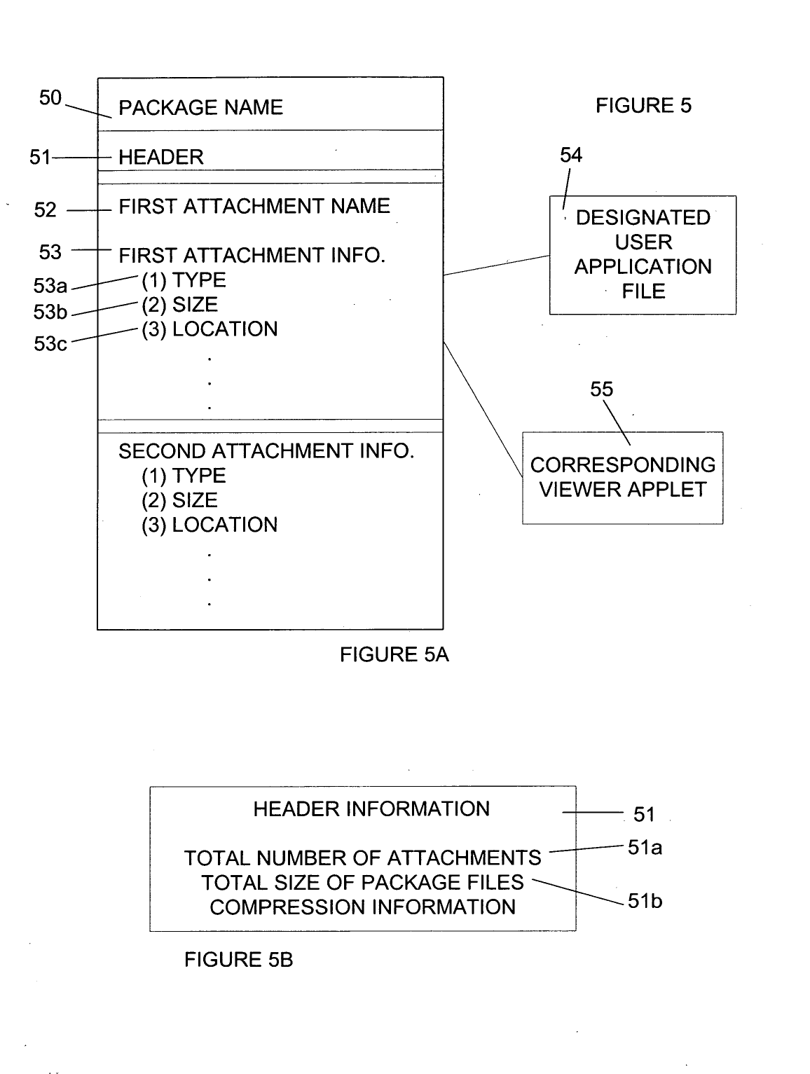

When an application file is designated as an attachment, a pointer or link is then associated between the application file and a data structure for the package, as illustrated with reference to FIGS. 5a and 5b. As shown in FIG. 5a, the data structure contains the package name 50 defined to identify the package. As shown in FIG. 5b, the header information 51 stores information about the package itself, which may include the number of attachment files currently associated with the package 51a, the total size of the combination of attachment files 51b, and information regarding the capabilities for compressing the file. For each file designated as an attachment and associated with the package, the data structure includes the user-defined attachment name 52, and general attachment file information 53, including the file type 53a, file size 53b, file location 53c, etc. A pointer or link from the attachment information 53 to the user application file 54 is maintained. If the corresponding viewer applet is to be included, another pointer or link to the viewer applet 55 is maintained.

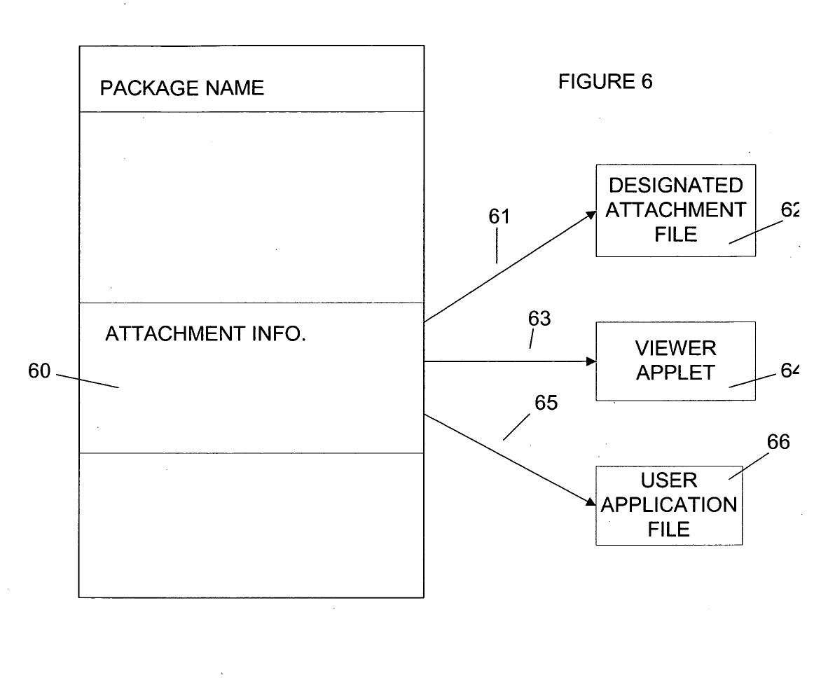

In an alternative embodiment, a copy of the user application file is made and stored as a separate file. In this data structure, shown in FIG. 6, the attachment information portion 60 maintains a link or pointer 61 to a new copy of the user application file, stored as designated attachment 62, and another link or pointer 63 to a copy of the corresponding viewer applet 64. In this embodiment, when a user application file is designated as an attachment, a copy is made of the user application file in its current form. Any subsequent edits to the user application after the user designates the file in a package are not automatically incorporated into the attachment file. However, because the user may desire to transmit the latest version of the user application, a second pointer is also maintained 65 to the user application file 66. When the user enters the email application and requests to include a particular package as an attachment, the system can detect whether the user application file 66 has changed from the designated attachment 62, and the user can choose which file to include in the package. Although it is more cumbersome to store a separate copy of the user application file to be attached, this embodiment provides additional functionality for the user.

As a third embodiment, the present disclosure further includes an attachment delayed-delivery module that temporarily suspends delivery of the viewer applet attachment at the sender's email server, until the viewer is requested by the recipient. If the viewer applet attachment is not requested within an email session, the viewer applet is deleted from the sender's server. The attachment delayed-delivery module allows a recipient's email communications system to automatically request transmission of the viewer applet over the network when necessary to view an attachment in an email communication. When the viewer applet is not necessary for the recipient, the attachment delayed-delivery module reduces unnecessary traffic over the network.

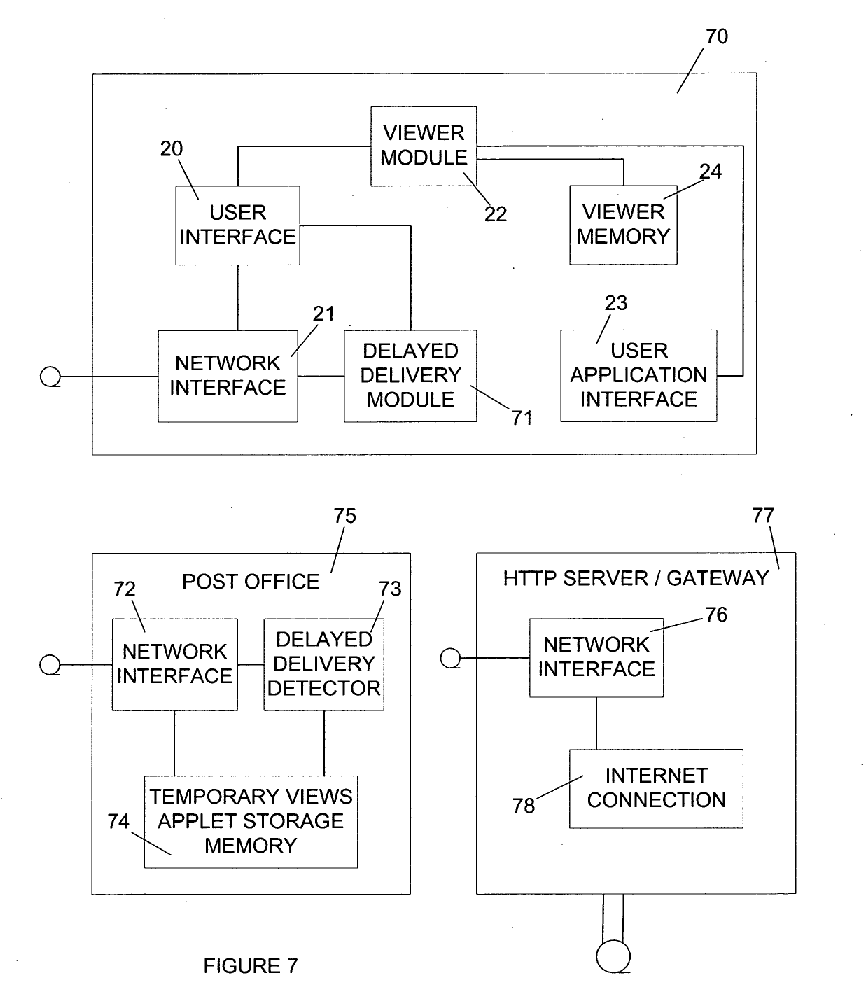

The configuration of an email communications system incorporating an attachment delayed-delivery module is explained with reference to FIG. 7. The email communications system 70 includes the user interface 20, network interface 21, viewer module 22, viewer memory 24, and user application interface 23, as shown in FIG. 2 above. The system 70 also includes a delayed delivery module 71, connected to the user interface 20 and the network interface 21, in order to send viewer applet attachments in separate emails that are transmitted to the recipient only upon request by the recipient. The applet attachments may also be sent by http if requested through a hyperlinked icon.

Through network interface 21, delayed delivery module 71 transmits attachments of viewer applets to server 75. This is received by network interface 72, detected by delayed delivery detector 73, and temporarily stored in temporary memory 74. If the destination address provided with the email communication is for an email client external to the network, to be transmitted via the internet, the original email communication including the attachment is forwarded from server 75 to the http server/gateway 77, through network interface 76, and on to the internet connection 78.

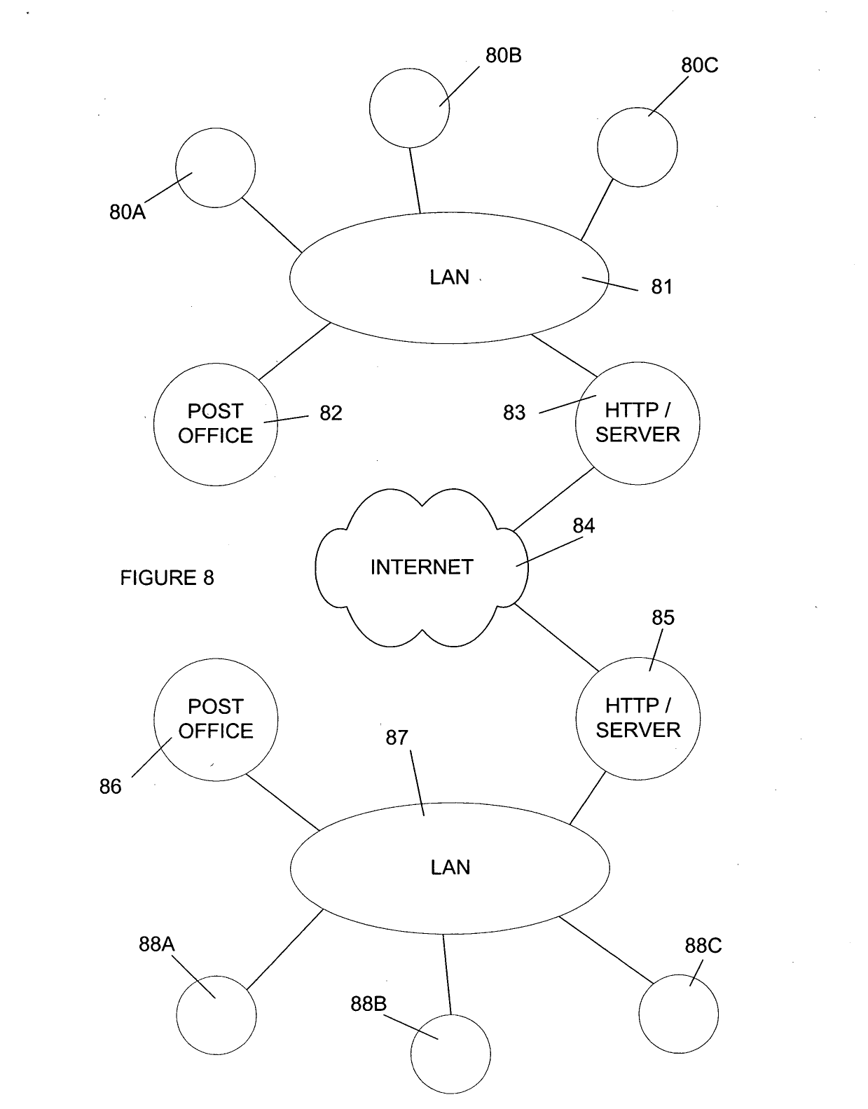

The operation of an email communications system incorporating an attachment delayed-delivery module is explained with reference to FIG. 8, in which an email communication with an attachment is transmitted from computer 80a to computer 88c via the Internet 84. Computers 80a, 80b, and 80c are connected together via LAN 81. Server 82 connects to LAN 81 for transmitting email both within and outside the LAN network. A world wide web hyper text transport protocol (HTTP) server 83 (web server), or internet gateway, is also connected to the LAN 81 for facilitating communication between any of the computers 80a, 80b, and 80c with other computer systems via the internet 84. Likewise, computers 88a, 88b, and 88c are connected together through LAN 87, which is also connected to server 86 and web server 85.

When a user stationed at computer 80a sends an email communication having a message and one or more attachment files, an email application program running on computer 80a performs initial formatting and then forwards the communication to the LAN 81 for transmission. This email communication does not include any viewer applets, but may include an indicator that one or more viewer applets are available for transmission. The LAN receives the communication and forwards it to post office server 82. Post office server 82 first determines whether the email is a local communication within the LAN network. When the email is not a local communication, the email communication is forwarded at the internet gateway 83 and reformatted according to a MIME or UUEN code format for transmission along the internet.

The email is then received at the destination internet gateway 85, reformatted, and forwarded to destination post office 86. A notification message is generated at the post office 86 and transmitted along LAN 87 to destination computer 88c. When a user at the destination computer 88c elects to read or retrieve the email communication, the LAN 87 forwards the email communication directly to the destination computer 88c. This email communication includes at least one icon for the recipient to select to receive viewer applets for viewing the one or more email attachments. Selecting an icon may, among other implementations, retrieve or open an applet through an executable program or the icon may be hyperlinked to retrieve or open a file at a URL using an internet browser.

The email communications system at computer 80a then transmits one or more viewer applets corresponding to the respective one or more attachment files in the transmitted email communication. The applets are transmitted along the LAN 81 to post office server 82. The applets are detected by a delayed delivery detector (not shown) and are temporarily stored at post office server 82. After delivery of the email communication, if a recipient selects an icon to request the one or more applets, a signal is transmitted by the recipient's email communication system for detection by the delayed delivery detector. Post office server 82 then downloads the requested viewer applets for transmission to the recipient. The viewer applet is then deleted from post office server 82.

In a second mode of operation, the email that is transmitted to the recipient includes a “viewer applet icon.” If the recipient of the email communication is unable to view an attachment, the recipient can select the icon. This sends a return email to the sender's address. The return email has a code in the subject heading portion that prompts the sender's email post office. Accordingly, the sender's email post office intercepts this email and then sends the viewer applet as an attachment to an email communication to the requesting recipient.

Among the several systems that are used to send and receive email messages, two of the most prominent are an SMTP/POP email system and a web-browser based system. An SMTP/POP email system uses an SMTP Server as an outgoing mail server to send email messages (outbound email) and a POP (Post Office Protocol) server to store incoming email. In an SMTP/POP system, the user generally has an email client application which runs on the user's PC to send and retrieve mail from both of these servers. A web-browser based email system, can access email through a web browser connected to the internet. In this mode the email is actually viewed inside the web browser and any applications with their associated applets would need to be downloaded from the web-browser system.

As can be readily seen, the email communications system viewer module and delayed-delivery module provide several advantages to the sender and receiver for transmitting and reviewing email communications. The system allows for the most efficient use of the network by sending a viewer applet only when it is probable that the recipient would otherwise be unable to review an attachment. The viewer module can be configured in any of several possible modes of operation to balance network efficiency with the criticality of sending a viewer applet. With the delayed-delivery module, the email communications system sends the viewer applet only when requested by the recipient, thereby saving network resources.

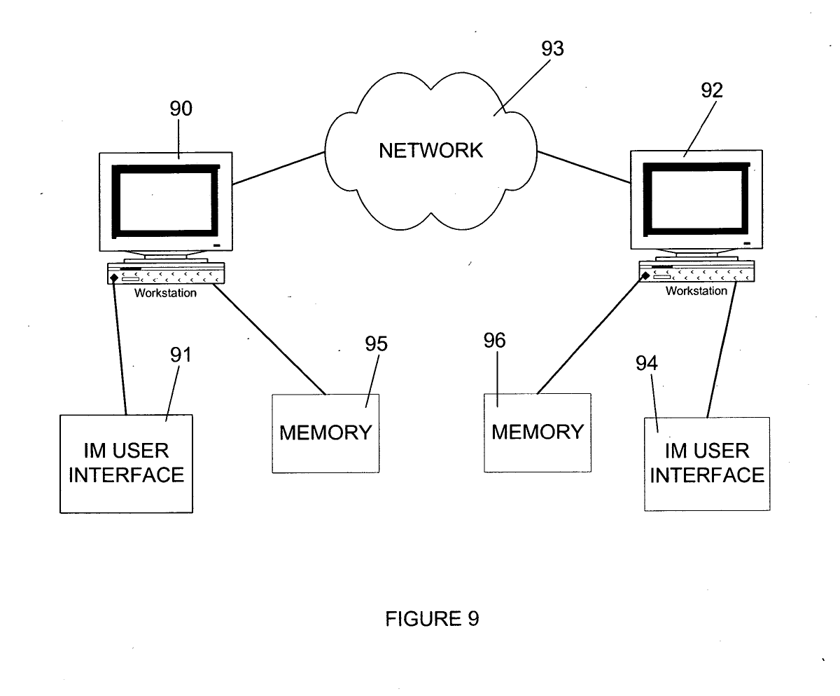

The present disclosure is also directed to a system and method for selectively attaching applets to IM communications when it is likely that the recipient of the IM communication will not be able to open or view an attachment file that is to be sent in the IM. FIG. 9 is a schematic diagram of a basic computer network system, in which computer 90 is connected to computer 92 through a network 93 to facilitate IM communications with attachments. Computer 90 has an IM communications user interface 91 that permits the computer to send IM communications using network 93. Likewise, computer 92 has an IM communications user interface 94 that permits the computer to receive IM communications from network 93. Computers 90 and 92 additionally include memories 95 and 96, respectively, for storing a plurality of user applications, which may or may not include as non-limiting examples software packages for word processing, CAD, mathematical equation editing, video editing, graphics, multimedia presentations, etc as well as applets for each of the user applications. Although only two computers 90 and 92 are shown in FIG. 9 for ease of illustration, it will be appreciated that any number of computers or other types of devices capable of IM communications may be used.

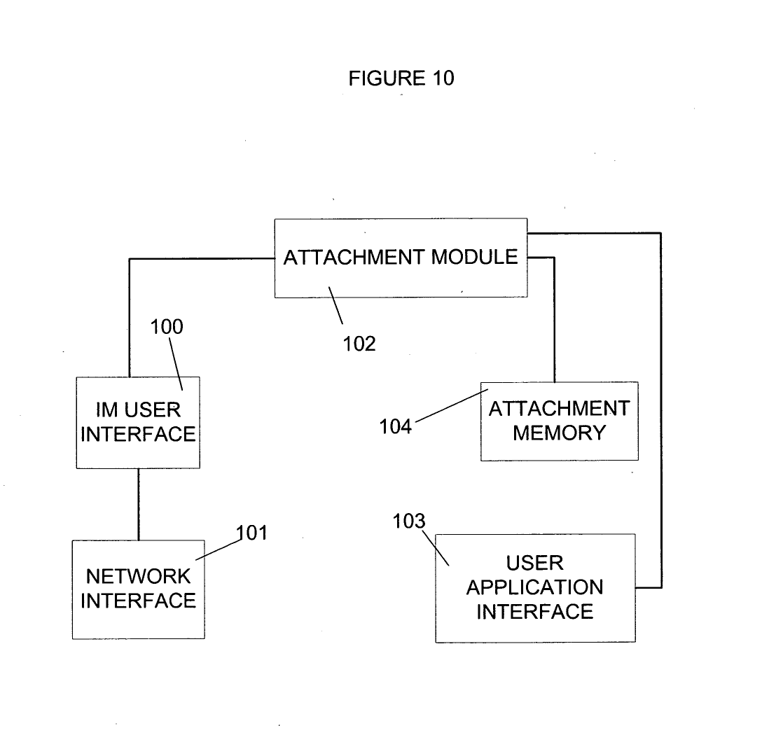

As shown in FIG. 10, an IM communications system according to one embodiment includes an IM user interface 100 by which a user composes IM communications. A network interface 101 is connected to the user interface for transmitting and receiving IM communications, and for transmitting or receiving applets used for opening attachment files. IM user interface 100 is also connected to attachment module 102. As will be explained below, attachment module 102 controls the placement and transmission of applets in outgoing IM communications, and enables a user to open attachment files in incoming IM communications. Attachment module 102 is connected to the user application interface 103 to receive applets from other user application software packages that are installed on the user's computer system. Attachment memory 104 may store executable programs and/or applets for commonly used user applications. Attachment memory 104 may be a special memory bank, or it may be part of memory 95 from FIG. 9.

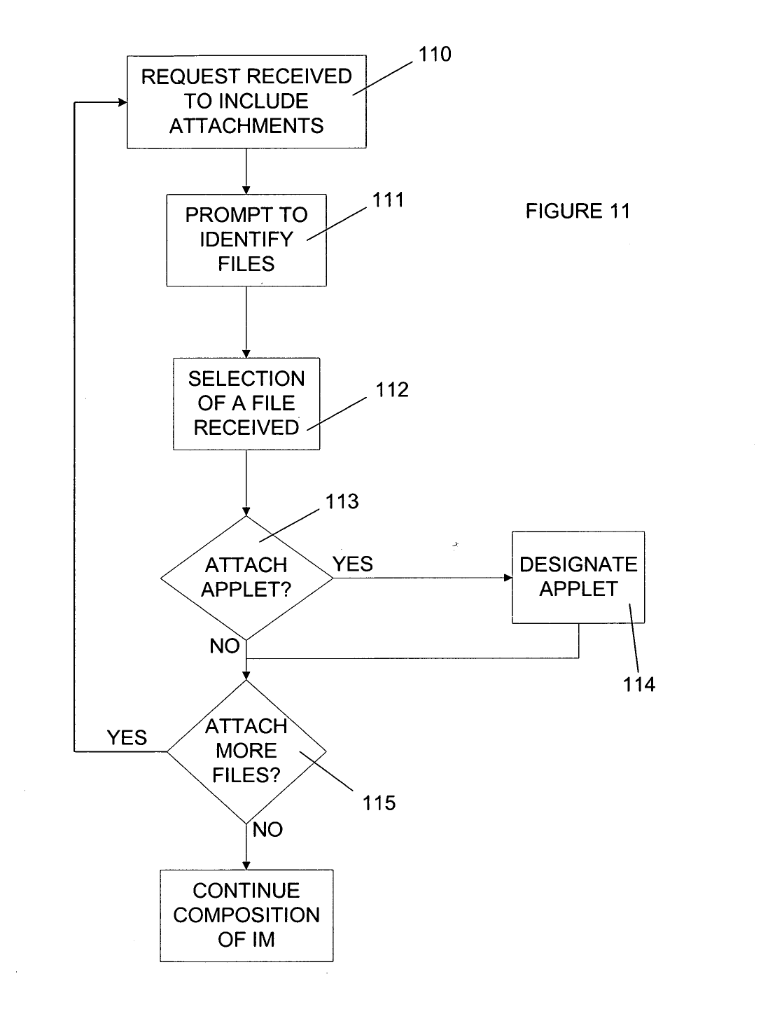

In an exemplary embodiment, attachment module 102 of FIG. 10 attaches an applet corresponding to an attachment file during the assembly of an IM communication. The flow diagram in FIG. 11 is an example of the steps that could be used to implement this embodiment. When a user elects to include an attachment with an IM communication, a signal is sent to the attachment module, as shown in step 110. A menu prompt is provided in step 111 to select one or more files to attach to the IM communication. The menu prompt of step 111 is generated in the user-interface 100 shown in FIG. 10. It allows the user to access file information maintained in a document management system in either the IM communications system itself, the computer's operating system, or on the network to which the user's computer is attached.

Once a file is selected to be an attachment in step 112, the attachment module 102 determines whether to add the applet that corresponds with the attachment file, in step 113. The attachment module can be configured for several possible modes of operation. In one mode of operation, attachment module 102 always adds the corresponding applet to the IM communication. One advantage of this mode is that it provides the highest degree of certainty that any recipient should be able to view attachments from the sender, although on many occasions the recipient would otherwise be able to view these files. In a second mode of operation, the sender is prompted to elect whether to include an applet corresponding to the selected attachment. This mode allows the sender to avoid unnecessarily sending the applet when the sender knows that the recipient's computer is capable of displaying the file.

In a third mode of operation, the attachment module prompts the sender to include an applet only when it is likely that the recipient does not have the corresponding applet or application software. This can be performed by referring to a list of file types stored in the attachment memory 104, and only prompting the sender to send an applet when the selected attachment file type is not among those in the list. Another method is to generate the prompt when the sender's own IM communication system would not be able to open the attachment. That is, a prompt is generated when the software stored in attachment memory 104 does not include a component for opening the attached file.

If the sender elects to include an applet, the applet is added to the IM communication for transmission to the recipient, in step 114. The applet may be copied from the application software package by which the attachment file was created, through application interface 103 in FIG. 10. It is also possible that the sender's computer has third party viewer software, for example, from which a component corresponding to the relevant application software is then extracted and attached to the IM. This process is repeated until the sender indicates that there are no more attachment files to be selected, in step 115. The sender can then continue to compose the IM communication in the normal course.

In a second embodiment, the attachment module is incorporated into a system that allows the user to configure groups of application files attached to an IM communication as packages. In this system, the user can designate a file to be a part of a new or an existing package of application files from within the user application software. The packages of application files, as defined by the user, can then be included as an IM attachment in a future IM communication. At the time when the user designates a file to be an attachment, the attachment module determines whether to include an applet in the IM communication by the modes of operation disclosed with respect to FIG. 11.

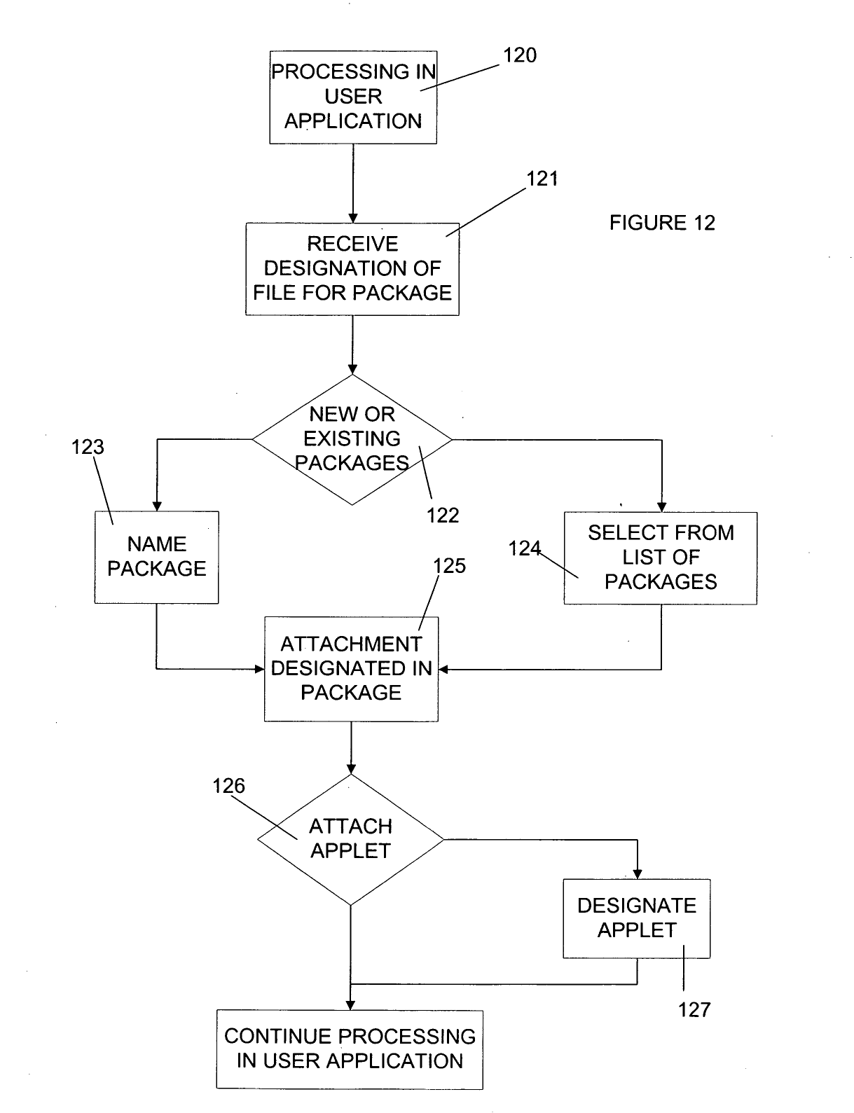

FIG. 12 provides a flow diagram illustrating how the IM application interfaces with a user application to coordinate the composition of packages of designated files for attachments and the attachment of applets. A user opens a user application, as in step 120, and begins to process an application file in the normal course. In this context, processing may include creating a new file, or opening and editing an existing file. The application files may be in a text format or any graphics, audio/video, or multimedia-type format. Graphics files might include jpeg, tif, or gif files among others. At any time during processing of the file, the user may choose to designate the application file for a package, as in step 121. This may be done by selecting an icon that is overlaid onto the screen of the user application. Alternatively, the user application itself may incorporate a macro within its menu or in its “toolbar” for creating IM attachment packages.

The user is then prompted to select an appropriate package for the designated file, in step 122. As one option, the user may choose to create a new package. If so, the system prompts the user to identify a package name, in step 123. Optionally, the system may create an icon that is to be associated with the package. If the user wishes to add the attachment file to an existing package, the system prompts the user to select from a list of packages, by name or by icon, or to provide the desired package name, in step 124. In step 125, the user application file is now designated as an attachment for a particularly defined package.

When an application file is designated as an attachment, the attachment module 102 in FIG. 10 determines whether to add the applet that corresponds with the attachment file, as in step 113 of FIG. 11. The step of determining whether to attach an applet in step 126 of FIG. 12 can be automatic, user-selected, or a combination of the two, as explained above. If an applet is to be included in the IM communication, the applet is designated as another attachment for the defined package in step 127.

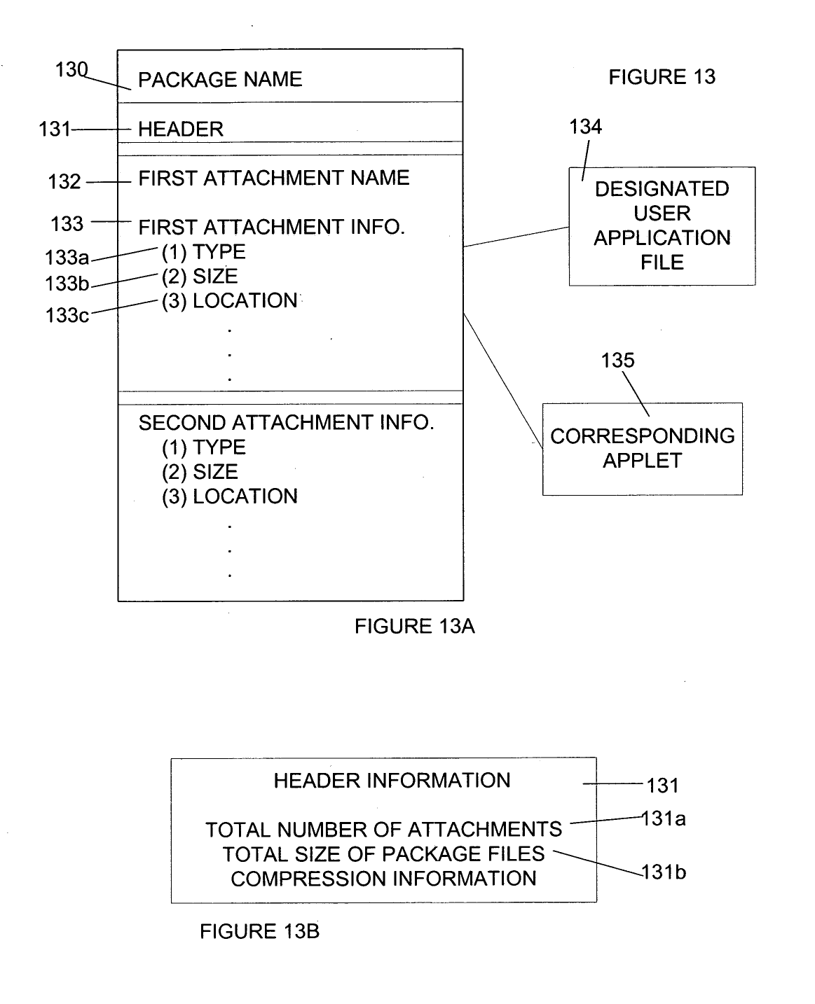

When an application file is designated as an attachment, a pointer or link is then associated between the application file and a data structure for the package, as illustrated with reference to FIGS. 13a and 13b. As shown in FIG. 13a, the data structure contains the package name 130 defined to identify the package. As shown in FIG. 13b, the header information 131 stores information about the package itself, which may include the number of attachment files currently associated with the package 131a, the total size of the combination of attachment files 131b, and information regarding the capabilities for compressing the file. For each file designated as an attachment and associated with the package, the data structure includes the user-defined attachment name 132, and general attachment file information 133, including the file type 133a, file size 133b, file location 133c, etc. A pointer or link from the attachment information 133 to the user application file 134 is maintained. If the corresponding applet is to be included, another pointer or link to applet 135 is maintained.

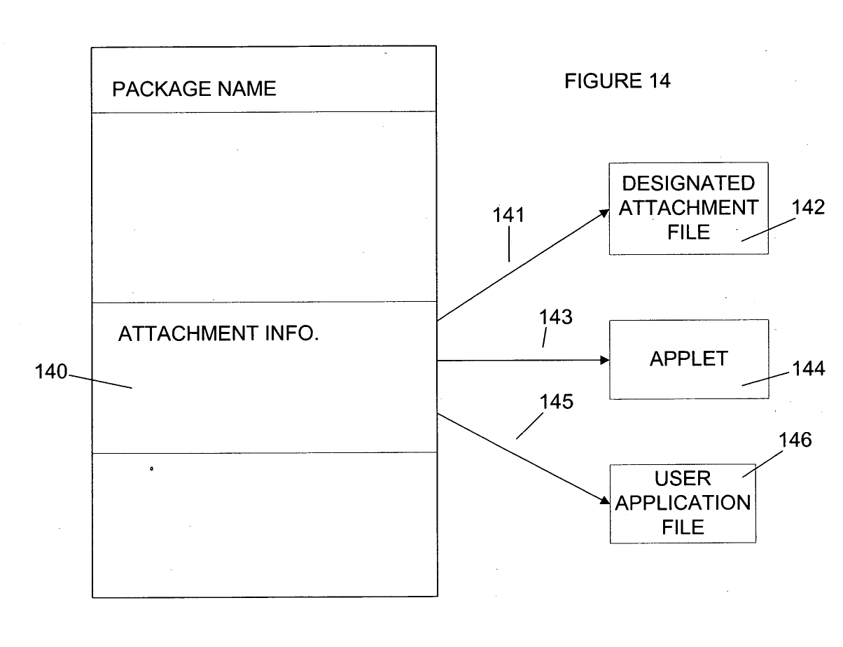

In an alternative embodiment, a copy of the user application file is made and stored as a separate file. In this data structure, shown in FIG. 14, the attachment information portion 140 maintains a link or pointer 141 to a new copy of the user application file, stored as designated attachment 142, and another link or pointer 143 to a copy of the corresponding applet 144. In this embodiment, when a user application file is designated as an attachment, a copy is made of the user application file in its current form. Any subsequent edits to the user application after the user designates the file in a package are not automatically incorporated into the attachment file. However, because the user may desire to transmit the latest version of the user application, a second pointer is also maintained 145 to the user application file 146. When the user enters the IM application and requests to include a particular package as an attachment, the system can detect whether the user application file 146 has changed from the designated attachment 142, and the user can choose which file to include in the package. Although it is more cumbersome to store a separate copy of the user application file to be attached, this embodiment provides additional functionality for the user.

In an alternative embodiment, an attachment delayed-delivery module temporarily suspends delivery of the applet attachment at the sender's IM server, until the applet is requested by the recipient. If the applet attachment is not requested within an IM session, the applet may be deleted from the sender's server. The attachment delayed-delivery module allows a recipient's IM communications system to automatically request transmission of the applet over the network when necessary to open an attachment in an IM communication. When the applet is not necessary for the recipient, the attachment delayed-delivery module reduces unnecessary traffic over the network.

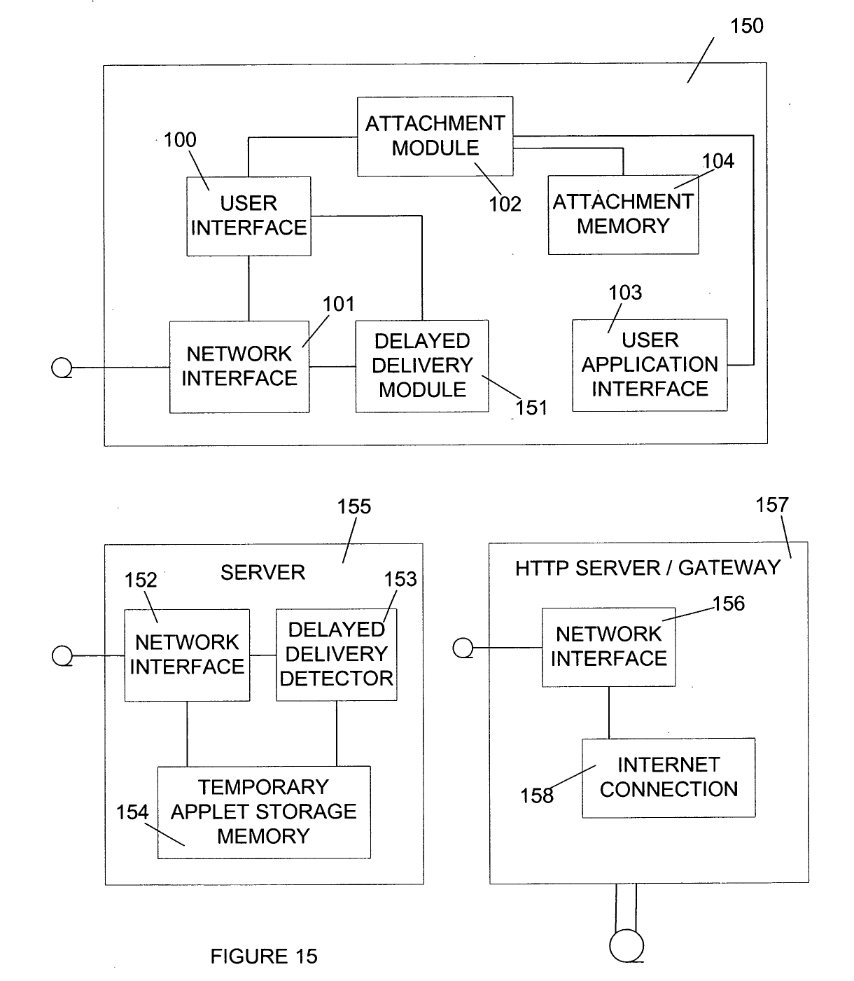

The configuration of an IM communications system incorporating an attachment delayed-delivery module is explained with reference to FIG. 15. The IM communications system 150 includes the user interface 100, network interface 101, attachment module 102, attachment memory 104, and user application interface 103, as shown in FIG. 10 above. The system 150 also includes a delayed delivery module 151, connected to the user interface 100 and the network interface 101, in order to send applet attachments in separate IMs that are transmitted to the recipient only upon request by the recipient.

Through network interface 101, delayed delivery module 151 transmits attachments of applets to server 155. This is received by network interface 152, detected by delayed delivery detector 153, and temporarily stored in temporary memory 154. If the destination address provided with the IM communication is for an IM client external to the network, to be transmitted via the internet, for example, the original IM communication including the attachment is forwarded from server 155 to the http server/gateway 157, through network interface 156, and on to the internet connection 158.

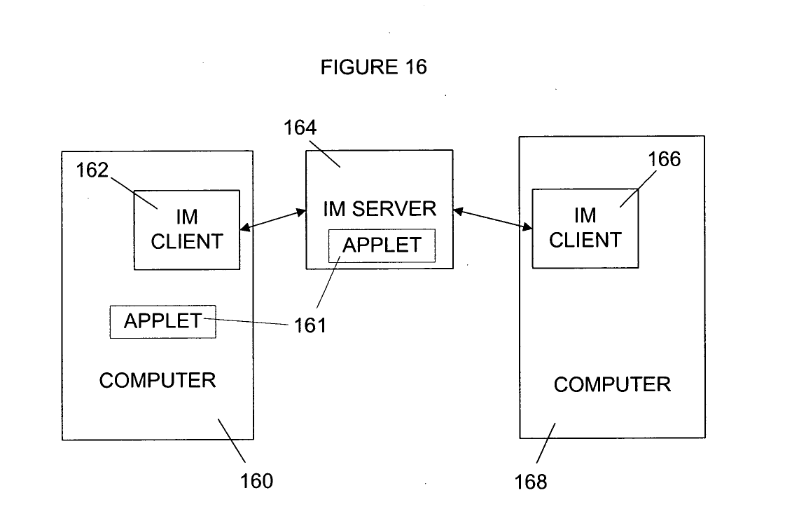

The operation of an IM communications system incorporating an attachment delayed-delivery module is explained with reference to FIG. 16, in which an IM communication with an attachment is transmitted from computer 160 to computer 168. Computer 160 is running IM client 162 and computer 168 is running IM client 166. IM server 164 connects IM clients 162, 168 for transmitting IM communications.

When a user stationed at computer 160 sends an IM communication having a message and one or more attachment files, an IM client program 162 running on computer 160 performs initial formatting and then forwards the communication to the IM server 164 for transmission. This IM communication may include no applets, but may include an indicator that one or more applets 161, which may reside on computer 160 or IM server 164, are available for transmission. Alternatively, the applet, resident on either computer 160 or IM server 164, is included with each IM that includes an attachment. The IM server 164 transmits the communication to IM client 166.

The IM is then received at the IM client 166 where the IM communication is displayed at the destination computer 168. This IM communication may include at least one icon or key to automatically request the applet if the application is not resident on the recipient's computer. The recipient may select the icon to request the applet(s), or the key may be able to detect the need for the applet(s) and automatically request the applet(s) on behalf of the user.

The IM communications system at computer 160 then transmits the applets corresponding to the respective attachment files in the transmitted IM communication to IM server 164. After delivery of the IM communication, if a recipient selects an icon to request the applets, a signal is transmitted by the recipient's IM communication system for detection by the delayed delivery detector. IM client 162 then downloads the requested applets from IM server 164 for transmission to the recipient.

In a second mode of operation, the IM that is transmitted to the recipient includes an “applet icon.” If the recipient of the IM communication is unable to view an attachment, the recipient can select the icon. This sends a return IM to the sender's address. The return IM has a code in the message that prompts the sender's IM server or client. Accordingly, the sender's IM server or client intercepts this IM and then sends the applet as an attachment to an IM communication to the requesting recipient.

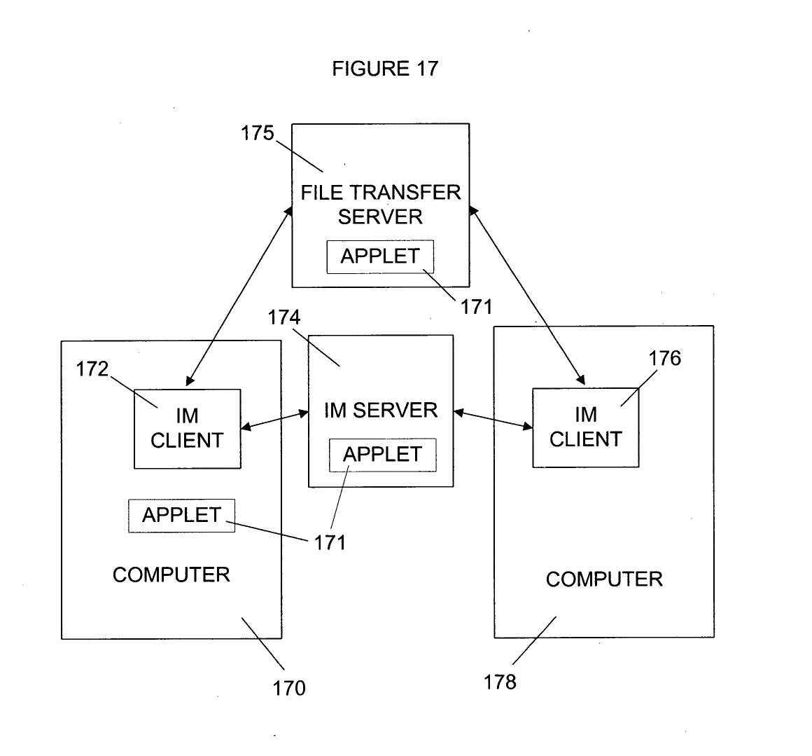

The IM communication system of FIG. 16 allows transfer of attachment files and applets over the IM network. One implementation of a system according to FIG. 16 is referred to as a “drag and drop” system, where the file is selected and dragged into the IM session window. However, other IM systems only allow text over the IM network, sending any attachment files separately through a file transfer server. Such a system is shown in FIG. 17. In FIG. 17, computer 170 is running IM client 172 and computer 178 is running IM client 176. IM server 174 connects IM clients 172, 178 for transmitting IM communications.

When a user stationed at computer 170 sends an IM communication having a message and one or more associated attachment files, an IM client 172 running on computer 170 performs initial formatting and then forwards the communication without the attachment file to IM server 174 for transmission. IM client program 172 sends the attachment to file transfer server 175 via webdav (web-based distributed authoring and versioning) or some other protocol, and a message is created to notify the recipient that the file is awaiting retrieval from the server for later retrieval. This IM attachment file may or may not include any applets 171, which may initially reside on computer 170, IM server 174, or file transfer server 175; but, if not, it may include an indicator, such as an icon, that one or more applets, originally resident on computer 170, are available for transmission. A hyperlinked icon may be used by the recipient to retrieve the applet from the file transfer server 175.

The IM message is then received at IM client 176 where the IM communication is displayed at destination computer 178. This IM communication may include at least one icon for the recipient to select such that the attachment file that is to be sent to file transfer server 175, perhaps by webdav and saved in a directory on file transfer server 175, is sent to destination computer 178. The communication may also include at least one icon for the recipient to select such that the applets for opening the one or more IM attachments are sent to destination computer 178. The icon may be for an executable file that downloads one or both of the attachment and the applet. In an exemplary embodiment, the applet may be transmitted to file transfer server 175 until retrieved by the user of computer 178.

In an exemplary embodiment, the attachment that is transmitted to the recipient includes an “applet icon.” If the recipient of the IM communication is unable to view an attachment, the recipient can select the icon. This sends a return IM to the sender's address. The return IM has a code in the message that prompts the sender's IM server. Accordingly, the sender's IM server 174 intercepts this IM and IM server 174, or file transfer server 175 if so implemented, then sends the applet as an attachment to an IM communication to the requesting recipient.

As can be readily seen, the IM communications system attachment module and delayed-delivery module provide several advantages to the sender and receiver for transmitting and viewing IM communications. The system allows for the most efficient use of the network by sending an applet only when it is probable that the recipient would otherwise be unable to open an attachment. The attachment module can be configured in any of several possible modes of operation to balance network efficiency with the criticality of sending an applet. With the delayed-delivery module, the IM communications system sends the applet only when requested by the recipient, thereby saving network resources.

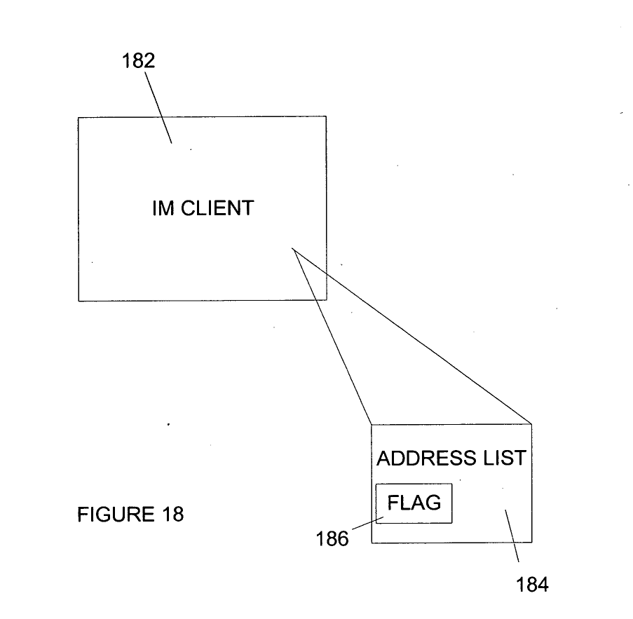

If a particular file type is sent multiple times to the same address, it may not be desirable to send the associated applet each time. In this case, as provided in FIG. 18, a flag can be set in the IM client such that redundant applet transmission is avoided. Many IM client applications have some type of address book, commonly called a “buddy list.” To avoid multiple applet transmission, flag 186 is set by a flag module when an applet for a particular file type is transmitted to an address on buddy list 184. For subsequent transmissions of the particular file type, IM client 182 determines whether the associated applet is to be sent by checking flag 186. If flag 186 is set, the attachment of the applet is aborted, or, in other words, the attachment is sent without the associated applet.

In an alternative embodiment, when the user of the receiving IM client saves the applet, an IM message is automatically sent (possibly in the background) to set flag 186 in buddy list 184. If the applet is deleted at some point and an IM session is open, an IM message is automatically sent (again, possibly in the background) to reset flag 186.

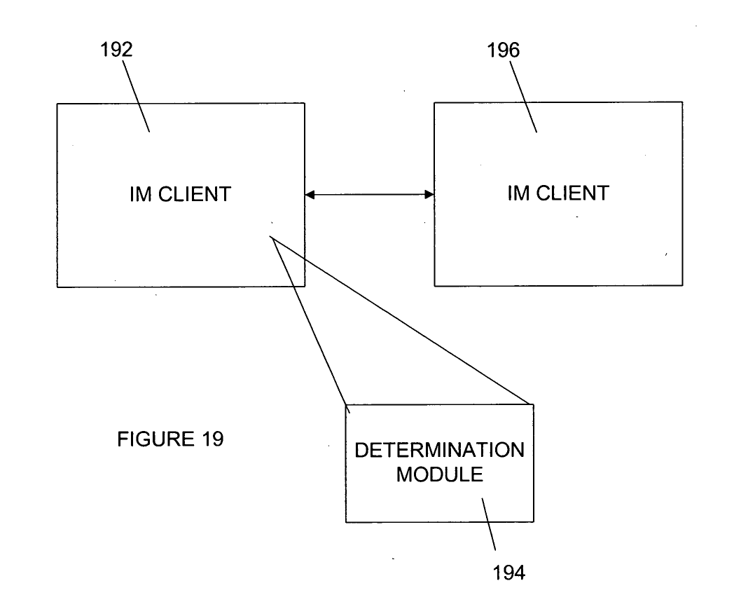

In another exemplary embodiment, provided in FIG. 19, the IM communication does not use an IM server, for at least a portion of a session. Instead the connection is point to point. IM client 192 obtains the IP address of IM client 196. IM client 192 is in direct communication with IM client 196. In this case, the IM server is not present to handle the applet inclusion determination. Instead, IM client 192 has a determination module 194 to monitor the transmission. If determination module 194 determines that there is non-text content, IM client 192 either sends the applet as well, or sends an icon or other method for IM client 196 to request the applet.

Embodiments of applets include viewers, but also limited editors. Limited editors, as a non-limiting example, may include the capability of viewing a spreadsheet or table and allowing the modification of data only in specified fields. A non-limiting example of another feature of an applet includes an annotation feature, which may be implemented in a comment bar, in one example.

The foregoing disclosure of embodiments of the present disclosure and specific examples illustrating the present disclosure have been presented for purposes of illustration and description. It is not intended to be exhaustive or to limit the disclosure to the precise forms disclosed. Many variations and modifications of the embodiments described herein will be obvious to one of ordinary skill in the art in light of the above disclosure. The scope of the disclosure is to be defined only by the claimed appended hereto, and by their equivalents.

1. A method of communications comprising:
configuring a communication;
determining whether the communication includes an attachment; and
if the communication includes an attachment,
receiving a selection of a file to be included as an attachment to a communication;
determining an applet corresponding to the file to be included as an attachment; and
preparing the corresponding applet for transmission.

2. The method of communications according to claim 1, further comprising attaching a corresponding applet for each selected file.

3. The method of communications according to claim 1, further comprising:
storing a list of standard applets in a memory; and
generating a prompt to include an applet after receiving a selection of a file when the list does not include a corresponding applet for the file;
wherein the corresponding applet is attached after receiving a selection to attach the applet.

4. The method of communications according to claim 1, wherein the applet is part of a user application software package, and the applet corresponds to a file composed on the user application software package.

5. The method of communications according to claim 1, further comprising:
transmitting the communication including an attachment to a destination address;
transmitting the applet corresponding to the attachment to an intermediate location along a network for temporary storage until a request for the applet is received.

6. The method of communications of claim 1, further comprising:
upon determining that an attachment is included, attaching an applet corresponding to the attachment.

7. The method of communications of claim 1, further comprising:
upon determining that an attachment is included, prompting a user for attaching an applet corresponding to the attachment.

8. The method of communications of claim 2, further comprising:
setting a flag for a particular applet when the particular applet is attached; and
aborting subsequent attachment of the particular applet if the flag for the particular applet is set.

9. The method of communications of claim 1, wherein the communication is an instant message (IM) communication

10. A computer readable medium embodying a program of instructions executable by a computer for performing a method for attaching applets to communications, comprising:
logic for storing a program in a memory accessible to a communications interface for opening, by one or more recipients of a communication, attachments to communications;
logic for receiving from a user a file to be included as an attachment to a communication; and
logic for automatically generating a prompt to include an applet corresponding to the file to be included as an attachment after receiving the file from the user when the file cannot be opened by the program, wherein the corresponding applet is prepared for transmission after receiving a file to attach the applet.

11. The computer readable medium embodying a program of instructions executable by a computer for performing a method for attaching applets according to claim 10, wherein the applet is part of a user application software package, and the applet corresponds to a file composed on the user application software package.

12. The computer readable medium embodying a program of instructions executable by a computer for performing a method for attaching applets according to claim 10, further comprising:
logic for transmitting the communication including an attachment to a destination address;
logic for transmitting an applet corresponding to the attachment to an intermediate location along a network for temporary storage until a request for the applet is received.

13. The computer readable medium embodying a program of instructions executable by a computer for performing a method for attaching applets according to claim 10, further comprising:
logic for setting a flag for a particular applet when the particular applet is attached; and
logic for aborting subsequent attachments of the particular applet if the flag for the particular applet is set.

14. A communication system comprising:
a user interface for composing a communication;
a determination module for determining whether a communication includes an attachment; and
an attachment module for attaching an applet corresponding to an attachment included in a communication.

15. The communications system according to claim 14, further comprising:
a memory connected to the attachment module, the memory for storing a program for opening attachment files from within a communications system;
wherein the attachment module attaches an applet when the program cannot open the attachment file.

16. The communication system of claim 14, wherein the user interface provides a prompt to attach a corresponding applet upon a determination that an attachment is included in a communication.

17. The communication system of claim 16, wherein the attachment module attaches an applet to a communication selected by a user in response to the prompt.

18. The communication system of claim 17, further comprising a flag module for setting a flag for a particular applet when the particular applet is attached.

19. The communication system of claim 18, wherein subsequent attachments of the particular applet are aborted if the flag for the particular applet is set.

20. The communication system of claim 14, wherein the attachment module attaches an applet to a communication when a program cannot open the attachment.
